(19) United States
(12) Patent Application Publication
(10) Pub. No.: US 2020/0181967 A1
(43) Pub. Date: Jun. 11, 2020

(54) FRICTIONAL LOCKING ARRANGEMENT FOR A DRIVE OF A CLOSURE ELEMENT OF A MOTOR VECHICLE

(71) Applicant: BROSE FAHRZEUGTEILE GMBH & CO. KOMMANDITGESELLSCHAFT, BAMBERG, Bamberg (DE)

(72) Inventors: Daniela SCHWEIZER, Coburg (DE); Andre KRAEUSSLICH, Grosswalbur (DE); Norbert HESS, Coburg (DE); Dominik SCHREIBER, Erlangen (DE); Christian FRICKE, Stegaurach (DE)

(73) Assignee: Brose Fahrzeugteile GmbH & Co. Kommanditgesellschaft, Bamberg (DE)

(21) Appl. No.: 16/604,813

(22) PCT Filed: Apr. 11, 2018
(86) PCT No.: PCT/EP2018/000189

§ 371 Date: Feb. 5, 2020

(30) Foreign Application Priority Data
Apr. 11, 2017 (DE) 10 2017 107 839.8

(51) Int. Cl. E05F 15/622; E05F 1/10

(52) U.S. Cl. CPC E05F 15/622; E05F 1/1058; B60J 5/107; E05Y 2900/546; E05Y 2201/474; E05Y 2900/532

(57) ABSTRACT

The disclosure relates to a frictionally locking arrangement for a drive, which drive has an advancing gear mechanism, the frictionally locking arrangement having a carrier and at least one frictionally locking unit. In some embodiments at least one frictionally locking unit has a frictionally locking lever which is mounted with a first lever end pivotably on the carrier, which frictionally locking lever, on a first lever section which is spaced apart from the first lever end, has a force introduction device which is mounted on the carrier and is configured to introduce a force into the frictionally locking lever in a manner which is spaced apart from the first lever end, and which frictionally locking lever, on a second lever section which is arranged between the first lever end and the first lever section, has a first frictional element.

### FIELD OF THE TECHNOLOGY

The disclosure relates to a frictionally locking arrangement for a drive of a closure element of a motor vehicle, to a drive for the motorized adjustment of a closure element of a motor vehicle, to a closure element arrangement of a motor vehicle, and to a method for producing a frictionally locking arrangement.

### BACKGROUND

In the present case, the term “closure element” is to be understood broadly. It comprises, for example, a tailgate, a trunk lid, an engine hood, a side door, a cargo compartment hatch, a window pane, a lifting roof or the like of a motor vehicle. In the following, the field of use of the adjustment of a tailgate of a motor vehicle is in the foreground.

Specifically, the motorized adjustment of a tailgate or the like has established itself in recent years, in particular in the area of station wagons. In addition to a reliable and low-noise motorized adjustment, a high robustness with respect to malfunctions and operating errors plays an important role.

One example for a malfunction is the failure of the supply voltage of the motor vehicle in the case of an open tailgate. It is to be ensured here firstly that the tailgate does not close unintentionally as a result of its weight, but rather maintains its position. Secondly, an uncomplicated, manual adjustment of the tailgate is to be made possible.

In order to hold a corresponding closure element of a motor vehicle reliably in the open position and also in intermediate positions, frictionally locking arrangements are known from the prior art which have a braking action on at least one component of the advancing gear mechanism of the drive, in particular on the drive spindle of a spindle/spindle nut mechanism. Here, different variants of frictionally locking arrangements are known which differ, for example, in terms of their direction of action. Thus, DE 10 2014 114 617 A1 discloses, for example, an axially acting frictionally locking arrangement, in the case of which a frictionally locking unit transmits an axial frictional force to a rotatable drive component. DE 10 2014 117 008 A1 discloses, for example, a radially acting frictionally locking arrangement, in the case of which frictionally locking elements which are arranged radially around a mechanism component which is configured as a drive spindle are loaded with spring force in the radial direction against the drive spindle and produce a frictional moment as a result. As in the abovementioned prior art, in addition to a braking function, frictionally locking arrangements can also assume a coupling function which, in the case of overloading, decouples the mechanism partners, for example the drive spindle and the spindle nut.

Drives of the abovementioned type are to take up as little installation space as possible in the motor vehicle, for which reason individual components of the drive and a frictionally locking arrangement which is provided therein are configured to be as small as possible. At the same time, however, a reliable braking action is to be achieved in the case of a malfunction or operating error, for which reason the components of the frictionally locking arrangement have to transmit forces which are as great as possible and have to be of correspondingly stable design.

### SUMMARY

The disclosure is based on the problem of configuring and developing a frictionally locking arrangement of the type mentioned at the outset, in such a way that a drive with a frictionally locking arrangement can be realized in a particularly compact way, but the frictionally locking arrangement nevertheless ensures an optimum braking action.

In the case of a frictionally locking arrangement in accordance with the disclosure, the above problem is solved by way of the features described herein.

The fundamental consideration that the provision of one or more frictionally locking levers makes a slim overall design of a frictionally locking arrangement possible is essential here. The frictionally locking lever or levers can be accommodated in a relatively narrow installation space between the carrier and the mechanism component which extends therein. The carrier is, for example, a section of a vehicle body or vehicle door, or a separate housing which, in particular, surrounds the frictionally locking lever or levers. Accordingly, the frictionally locking lever or levers can be accommodated in an installation space between a housing inner side and the mechanism component which extends in the housing, for example in a narrow annular space between a housing which is, in particular, cylindrical and a spindle, extending therein, of a spindle drive as mechanism component. Despite the narrow installation space, the respective frictionally locking lever can also be of sufficiently stable configuration, by said frictionally locking lever having a relatively great width, which is readily possible in the case of the space which is available in the interior of a vehicle door or in the case of the space which is available within the abovementioned annular space.

Moreover, by way of the provision of one or more frictionally locking levers, physical lever laws can be utilized which make it possible to achieve a relatively great resulting pressing force of the lever or a frictional element which is arranged on the lever on the mechanism component to be braked by way of the introduction of a relatively low force into the lever.

It is to be noted that the mechanism component to be braked in question, for example the drive spindle, can carry out a rotating, pivoting and/or translational movement and/or can be configured in sections or completely with a thread or without a thread. Here, the respective frictionally locking unit or the respective frictionally locking lever or a frictional element which is connected to the respective frictionally locking lever can act both on a threadless section of the mechanism component or drive spindle and on a section thereof which is provided with a thread, in order to brake the movement thereof, in particular the rotational movement thereof.

Therefore, by way of the provision of one or more frictionally locking levers, the frictionally locking arrangement according to the proposal firstly makes a compact overall design possible, but secondly is also capable of reliably producing relatively great braking forces or braking moments.

As described above, it is possible by way of a frictionally locking lever to achieve a relatively great resulting force, in particular pressure force, in a second lever section by way of the introduction of a relatively low force in a first lever section which is spaced apart from the first lever end which forms the rotational axis, which second lever section is less far away from the rotational axis than the first lever section. The resulting force can then be utilized for braking a movement of the mechanism component. If, for example, the mechanism component moves purely translationally, a frictional force which brakes the translational movement is produced via the lever. If, for example, the mechanism component moves purely rotationally, a corresponding frictional moment which brakes the rotational movement is produced via the lever. A corresponding force introduction device which is a constituent part of the frictionally locking unit and which is arranged on said first lever section of the frictionally locking lever serves for the introduction of the force. Here, just like the frictionally locking lever with its first lever end, the force introduction device can be mounted on that side of the carrier which points toward the mechanism component or on the inner side of the housing, and can be supported on that side of the carrier which points toward the mechanism component or on the inner side of the housing.

In various embodiments, the force introduction device can be adjusted, which can be carried out, for example by means of a corresponding tool, in particular from that side of the carrier which faces away from the mechanism component or from outside the housing. An adjustment of the force introduction device brings about, in particular, a change in the position of the frictionally locking lever relative to the carrier or a change in the force, with which the frictionally locking lever is pressed away from the carrier, and accordingly a change in the frictional force or frictional moment which is produced by the first frictional element which is arranged on the second lever section.

The force introduction device can be configured in different ways. In particular, it has a spring, a fastening means for the spring and/or a guide element for the fastening means. Said elements of the force introduction device make an adjustment thereof possible in a particularly simple way and, as a result, make setting of the frictional force or frictional moment possible.

Various embodiments describe different configuration and arrangement options of the elements which characterize the force introduction device of spring, fastening means and guide element, and options for the interaction of said elements among one another or with the respective frictionally locking lever.

In accordance with various embodiments, a drive, in particular a spindle drive, for the motorized adjustment of a closure element of a motor vehicle is provided, which drive has a frictionally locking arrangement according to the proposal. Reference may be made here to all the comments in respect of the frictionally locking arrangement according to the proposal, insofar as they are suitable for describing the drive.

A particularly slim refinement is also provide herein, in particular if the drive is configured as a spindle drive.

In accordance with various embodiments, a closure element arrangement of a motor vehicle is disclosed having a closure element which is coupled adjustably to the body of the motor vehicle, and having at least one drive according to the disclosure, in particular a spindle drive, for the motorized adjustment of the closure element. Once again, reference may be made to all the comments in respect of the frictionally locking arrangement according to the proposal and in respect of the drive according to the proposal.

In various embodiments, a method for producing (assembling) a drive according to the proposal is provided, in the case of which method, in a first step, at least one frictionally locking unit is preassembled, by in each case at least the frictionally locking lever, the spring and the fastening means being assembled to form one unit, and, in a second step, the at least one preassembled frictionally locking unit is connected to the drive. Here, the preassembled unit is connected to the drive, in particular, in such a way that it can produce a braking force or a braking moment during operation of the frictionally locking arrangement or in the case of actuation of the drive. Once again, reference may be made to all the comments in respect of the frictionally locking arrangement according to the proposal and in respect of the drive according to the proposal and in respect of the closure element arrangement according to the proposal.

Finally, various embodiments relate to the method according to the proposal which further optimize the production or assembly of the frictionally locking arrangement according to the proposal.

Various embodiments provide a frictionally locking arrangement for a drive, in particular a spindle drive, of a closure element of a motor vehicle, which drive has an advancing gear mechanism with a mechanism component for producing drive movements, the frictionally locking arrangement having a carrier and at least one frictionally locking unit which is configured to transmit a frictional force and/or a frictional moment to the mechanism component, wherein the at least one frictionally locking unit has a frictionally locking lever which is mounted with a first lever end pivotably on the carrier, which frictionally locking lever, on a first lever section which is spaced apart from the first lever end, has a force introduction device which is mounted on the carrier and is configured to introduce a force into the frictionally locking lever in a manner which is spaced apart from the first lever end, and which frictionally locking lever, on a second lever section which is arranged between the first lever end and the first lever section, has a first frictional element which is configured to transmit the frictional force or the frictional moment to the mechanism component.

In various embodiments, the mechanism component is a drive spindle which, in particular, rotates.

In various embodiments, the frictionally locking lever, by way of its first lever end, and/or the force introduction device is mounted on the carrier, in particular on that side of the carrier which points toward the mechanism component, and, in some embodiments, the force introduction device is supported on the carrier, in particular on that side of the carrier which points toward the mechanism component.

In various embodiments, the force introduction device can be adjusted, in particular in such a way that an adjustment brings about a change in the position of the frictionally locking lever relative to the carrier and/or a change in the force, with which the frictionally locking lever is pressed away from the carrier.

In various embodiments, the force introduction device has a spring, in particular a helical spring, such as a helical compression spring, which loads the frictionally locking lever on the first lever section with a spring force, in particular an adjustable spring force, and, in some embodiments, the spring presses the frictionally locking lever away from the carrier, in particular toward the mechanism component.

In various embodiments, the force introduction device has a fastening means for the spring, which fastening means is configured to fix the spring on the frictionally locking lever, the fastening means being supported on the carrier, in particular on that side of the carrier which points toward the mechanism component.

In various embodiments, the fastening means is mounted, in particular is mounted in a sliding manner, on the frictionally locking lever, in particular in an opening in the frictionally locking lever, in some embodiments, wherein the fastening means is secured on the frictionally locking lever counter to the direction of action of the spring force, and, in some embodiments, wherein the fastening means comes into contact with the frictionally locking lever on that side of the frictionally locking lever which faces away from the carrier.

In various embodiments, the force introduction device has a guide element for the fastening means, and, in some embodiments, wherein the fastening means has a first thread, in particular an external thread, and the guide element has a corresponding second thread, in particular an internal thread, the fastening means and the guide element being in screwed engagement with one another.

In various embodiments, the spring is fixed and, in particular, prestressed between the guide element, in particular a collar of the guide element, and the frictionally locking lever.

In various embodiments, the fastening means and the guide element interact with one another in such a way that a rotation of the fastening means relative to the guide element brings about a change in the spacing between the guide element and the frictionally locking lever.

In various embodiments, the guide element has an anti-rotation safeguard which interacts with the frictionally locking lever, in particular in such a way that the guide element can be moved relative to the frictionally locking lever translationally, in particular away from the carrier, such as toward the mechanism component, but not rotationally or substantially not rotationally, and, in some embodiments, wherein the guide element has at least one fin as an anti-rotation safeguard, which fin interacts with a stop on the frictionally locking lever in the rotational direction of the fastening means.

In various embodiments, the fastening means has a shank, which is slotted, in particular, along the length at least once, such as multiple times, and/or a head which, in particular, has a receptacle for a tool, such as a hexagon socket or an external hex or a slot or cross slot as receptacle.

In various embodiments, the at least one frictionally locking unit, in particular at least comprising the frictionally locking lever, the spring and the fastening means, forms a preassembled unit, and wherein the guide element and/or the carrier are/is also part of the preassembled unit.

Various embodiments provide a drive, in particular a spindle drive for the motorized adjustment of a closure element of a motor vehicle, a frictionally locking arrangement as described herein.

In various embodiments, the drive has a drive motor and an advancing gear mechanism which is connected downstream of the drive motor, wherein the frictionally locking arrangement is connected between the drive motor and the advancing gear mechanism, and further, in some embodiments, wherein the advancing gear mechanism is configured as a spindle/spindle nut mechanism with a spindle and a spindle nut which is assigned to the latter.

Various embodiments provide a closure element arrangement of a motor vehicle having a closure element which is coupled adjustably to the body of the motor vehicle, and having at least one drive for the motorized adjustment of the closure element as described herein.

In various embodiments, in a first step, at least one frictionally locking unit is preassembled, by at least the frictionally locking lever, the spring and the fastening means being assembled to form one unit, and, in a second step, the at least one preassembled frictionally locking unit is connected to the drive.

In various embodiments, in the first step, furthermore, the guide element and/or the carrier are/is also preassembled together with at least the frictionally locking lever, the spring and the fastening means to form in each case one unit, and, in the second step, the respective preassembled unit is connected to the drive.

In various embodiments, in the first step, the fastening means is connected to the frictionally locking lever, in particular by way of latching, in some embodiments, wherein the fastening means is connected to the guide element before the connection to the frictionally locking lever, and further, in some embodiments, before the connection of the fastening means to the frictionally locking lever, the spring is arranged between the frictionally locking lever and the fastening means and/or guide element.

### BRIEF DESCRIPTION OF THE DRAWINGS

In the following text, various aspects of the disclosure will be described in greater detail on the basis of a drawing which illustrates merely one exemplary embodiment and in which:

FIG. 1 shows a highly diagrammatic illustration of the rear region of a motor vehicle having a closure element arrangement according to the proposal which has drives according to the proposal with in each case one integrated frictionally locking arrangement according to the proposal,

FIG. 2 shows one of the drives according to FIG. 1 in the retracted state in a partial longitudinal section,

FIG. 3 shows a frictionally locking arrangement in a partially sectioned view and in a plurality of sectional views, and

FIG. 4 shows a frictionally locking lever of the frictionally locking arrangement according to FIG. 3 in a plan view and in two sectional views which are orthogonal with respect to one another (FIG. 4a) and a section of the frictionally locking lever in a partial longitudinal section (FIG. 4b).

### DETAILED DESCRIPTION

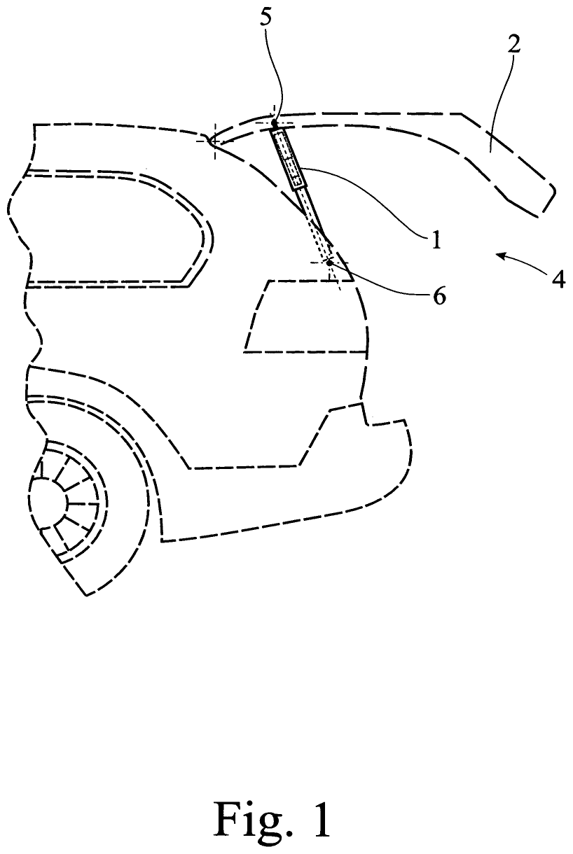

FIG. 1 shows one example of a drive 1 for the motorized adjustment of a closure element 2 of a motor vehicle, which drive 1 is configured here by way of example as a spindle drive 1. Here, the drive 1 serves to guide the power flow of the drive power which is produced by a drive motor 4 of the drive 1.

The application of the closure element 2 which is configured as a tailgate is in the foreground here. The solution according to the proposal can likewise be applied to all other types of closure elements, however. Reference may be made to the exemplary list in the introductory part of the description.

The tailgate 2 which is shown in FIG. 1 is assigned a total of two drives 1 which act on the two side edges of a tailgate opening 4 and on the tailgate 2 itself. Here, the drive 1 is assigned ball sockets 5, 6 on the end side which are in engagement with corresponding spherical heads on the respective side edge of the tailgate opening 4 and on the tailgate 2. The subject in the following text is merely the drive 1 which is visible in FIG. 1. All of the comments apply correspondingly to the drive which is not visible in FIG. 1 and lies behind it in the illustration and to an arrangement with only a single drive 1.

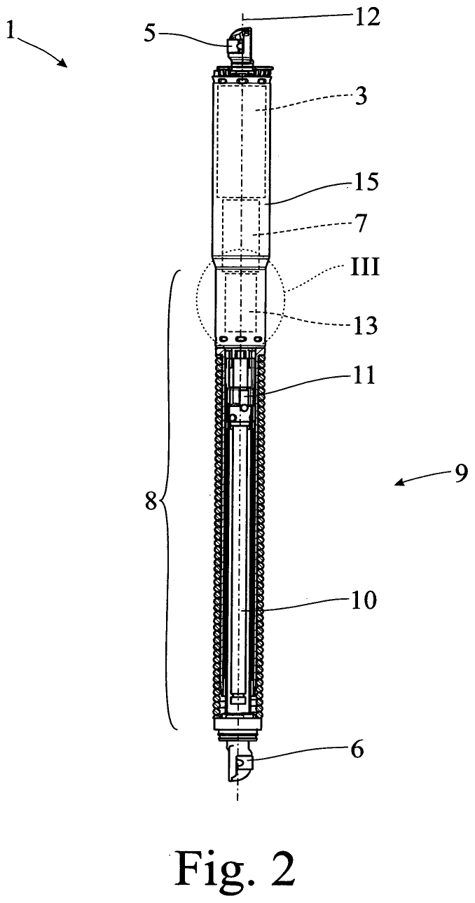

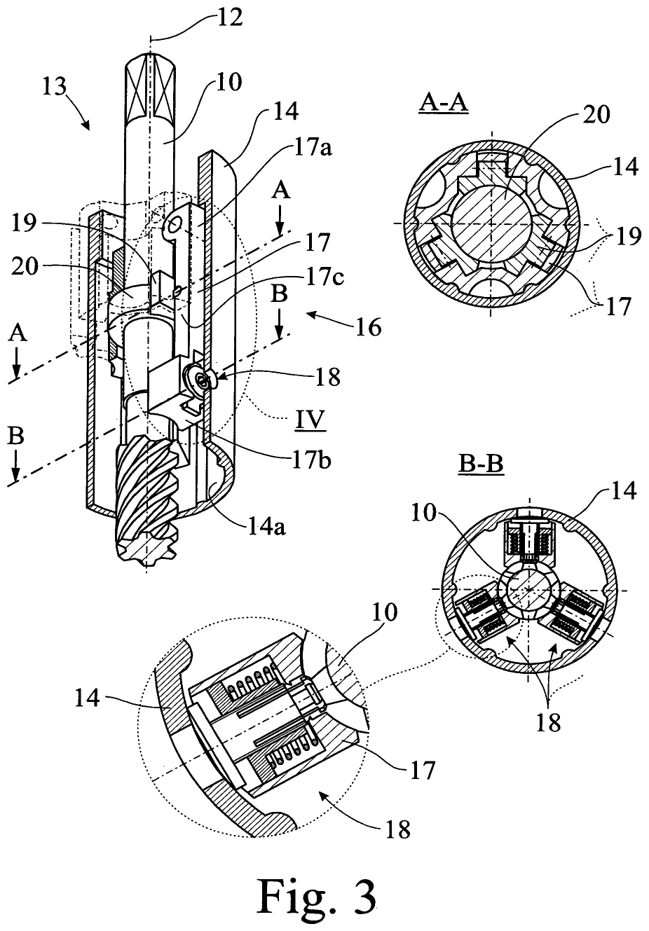

As FIG. 2 shows, an intermediate mechanism 7 (for example, in the form of a planetary gear mechanism) is connected (here) downstream of the drive motor 3, an advancing unit 8 with an advancing gear mechanism 9 in turn being connected downstream of said intermediate mechanism 7. Here, the advancing gear mechanism 9 is configured in a manner known per se as a spindle/spindle nut mechanism 9, and has a spindle 10 and a spindle nut 11 which is assigned to it for the production of linear drive movements along a geometric spindle axis 12 in the drive 1. Furthermore, a frictionally locking arrangement 13 according to the proposal is integrated into the drive 1 in a section of the advancing unit 8, which section is shown in FIG. 3.

The frictionally locking arrangement 13 which can be a constituent part of a braking mechanism or coupling mechanism of the advancing gear mechanism 9 has (here) a dedicated housing 14 as a carrier 14, but can also be fastened to a section of a vehicle body or vehicle door as a carrier 14. The carrier 14 can also be a constituent part of the drive housing 15 which is shown in FIG. 2 and radially surrounds the drive motor 3, the intermediate mechanism 7 and the frictionally locking arrangement 13. Furthermore, the frictionally locking arrangement 13 has one or more frictionally locking units 16 (here, precisely three frictionally locking units 16 which are arranged at an angle of 120° about the spindle axis 12), the frictionally locking units 16 being configured (here) in each case to transmit a frictional moment to the mechanism component 10 which is spindle-shaped here.

As FIG. 3 shows, the respective frictionally locking unit 16 has a frictionally locking lever 17 which is mounted pivotably by way of a first lever end 17a on the housing 14, and which has a force introduction device 18 on a first lever section 17b which is spaced apart from the first lever end 17a and is formed here by the second lever end. The force introduction device 18 is mounted on the inner side 14a of the housing 14, or is supported there, and is configured to introduce a force into the frictionally locking lever 17 in a manner which is spaced apart from the first lever end 17a. Finally, the frictionally locking lever 17 also has a second lever section 17c which is arranged between the first lever end 17a and the second lever end 17b and is provided with a first frictional element 19. The frictional element 19 is configured to transmit a force which results from the force which is introduced into the frictionally locking lever 17 via the force introduction device 18 to the mechanism component 10, and to produce a corresponding frictional moment here. The first frictional element 19 interacts (here) with a second frictional element 20 which is formed by way of a thickened section of the mechanism component 10.

It can be seen in the case of the exemplary embodiment which is shown that the first frictional element 19 acts on a section of the mechanism component 10 which (here) is a constituent part of the frictionally locking arrangement 13, which section is threadless. It is also fundamentally conceivable, however, that the first frictional element 19 acts on a section of the mechanism component 10, which section is provided with a thread.

The force introduction device 18 is (here) of adjustable configuration, to be precise in such a way that an adjustment brings about a change of the position of the respective frictionally locking lever 17 relative to the housing 14 and relative to the mechanism component 10, and/or a change in the force, with which the frictionally locking lever 17 is pressed away from the housing 14. In this way, the frictional force which is transmitted from the first frictional element 19 to the second frictional element 20 of the mechanism component 10 which is configured here as a drive spindle can be set individually and, in particular, can be readjusted over time if the frictional force should decline, for example, in a wear-induced manner.

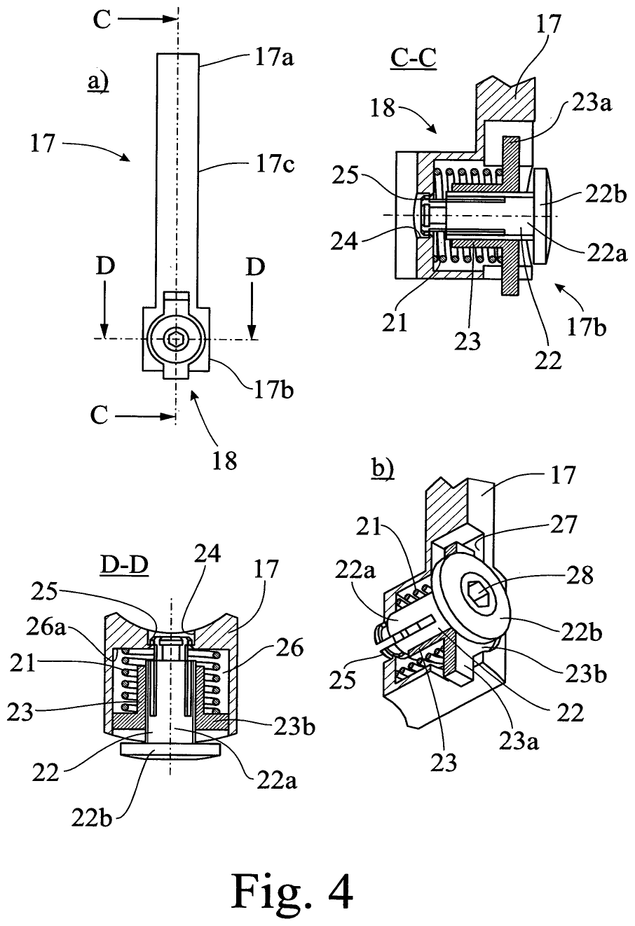

The individual constituent parts of the force introduction device 18 of the present exemplary embodiment can be seen in the section B-B in FIG. 3 and in FIGS. 4a) and b). According to this, the force introduction device 18 has a spring 21 in the form of a helical compression spring, a fastening means 22 for the spring 21, and a guide element 23 for guiding the fastening means 22 in the radial direction.

The spring 21 serves to load the frictionally locking lever 17 on the first lever section 17b with a spring force which can be set here, in particular in such a way that the spring 21 presses the frictionally locking lever 17 away from the housing 4 radially to the inside.

A screw with a screw shank 22a and a screw head 22b is (here) provided as a fastening means 22 for the spring 21. Here, the shank 22a is provided with a first thread (not shown) in the form of an external thread which interacts with a corresponding second thread (likewise not shown) in the form of an internal thread of the guide element 23, with the result that the fastening means 22 and the guide element 23 are in screwed engagement with one another and can be rotated relative to one another.

The fastening means 22 is configured to fix the spring 21 on the frictionally locking lever 17. To this end, the shank 22a tapers in the present case in a section which is guided through an opening 24 in the frictionally locking lever 17 and is mounted in the opening 24 in a sliding manner. At that end which faces the mechanism component 10, the shank 22a widens at least in sections and, as a result, forms, in particular, latching lugs 25 which come into contact with the frictionally locking lever 17 on that inner side of said frictionally locking lever 17 which faces away from the housing 14. In other words, the fastening means 22 is latched to the frictionally locking lever 17 here. As an alternative, it is also conceivable to provide a screwed or riveted connection instead of the latching, which is advantageous, in particular, in the case of relatively great spring forces. The securing which is configured in this way of the fastening means 22 on the frictionally locking lever 17 counter to the spring force can also be established and released again simply in the exemplary embodiment which is shown by virtue of the fact that the fastening means 22 is slotted, and in some embodiments is slotted four times here, at the lower end of the shank 22a and, as a result, can be compressed radially toward the inside, in order to be guided through the opening 24.

The spring 21 is arranged and fixed between the head 22b of the fastening means 22 and the frictionally locking lever 17, more precisely between the head 22b and a bottom 26a of a receiving chamber 26 for the force introduction device 18. Here, the fastening means 22 is supported with its head 22b on the inner side on the housing 14, and is pressed against the housing 14 by the spring 21 via the guide element 23.

In order to change the prestress of the spring 21, the fastening means 22 which is in screwed engagement with the guide element 23 can be rotated relative to the guide element 23. Since, as the anti-rotation safeguard 23a, the guide element 23 (here) has two fins which interact with a stop 27 in the rotational direction of the fastening means 22, the guide element 23 cannot corotate in the case of a rotational movement of the fastening means 22, which leads to the spacing between the guide element 23 and the frictionally locking lever 17 or the chamber bottom 26a changing. Said change in the spacing in turn brings about a change in the spring prestress of the spring 21 which is supported with its one end on the frictionally locking lever 17 or on the chamber bottom 26a and with its other end on a collar 23b of the guide element 23.

A rotation of the fastening means 22 relative to the guide element 23 can be brought about by virtue of the fact that the head 22b of the fastening means 22 has a receptacle 28 for a tool, which receptacle 28 is configured here as a hexagon socket.

In various embodiments, at least the individual frictionally locking units 16 in each case form a preassembled unit which (here) comprises the respective frictionally locking lever 17, the respective spring 21, the respective fastening means 22 and the respective guide element 23. A structural unit of this type can be seen in FIG. 4a) in a plan view. It is also conceivable to preassemble the preassembled frictionally locking units 16 on the housing 14 and, as a result, to form a further preassembled unit.

In accordance with various embodiments, the above drive 1 which has been described together with the frictionally locking arrangement 13 is provided. Accordingly, the drive 1 according to the proposal serves for the motorized adjustment of a closure element 2 of a motor vehicle. In various embodiments, which is shown in FIG. 2, the drive 1 is a spindle drive.

Various embodiments provide a closure element arrangement (shown in FIG. 1) of a motor vehicle. The closure element arrangement according to the proposal has a closure element 2 (in the form of a tailgate here) which is coupled adjustably to the remaining motor vehicle, and at least one drive 1 according to the proposal for the motorized adjustment of the closure element 2. In various embodiments, the drive 1 is of non-self locking configuration (that is to say, it can be driven in reverse), and that the frictionally locking arrangement 13 holds the closure element 2 in intermediate positions in the case of a switched off drive 1. In various embodiments, in the case of a switched off drive 1, the closure element 2 can be adjusted manually counter to the braking action of the frictionally locking arrangement 13. In this context, of particular significance in the fact that the arrangement overall is produced in such a way that the frictionally locking arrangement 13 holds the closure element 2 in intermediate positions in the case of a switched off drive 1, in particular with regard to the weight of the closure element 2 and possible spring arrangements which act on the closure element 2 and are, for example, gas spring arrangements or the like.

Finally, various embodiments provide a method for producing a drive 1 according to the proposal, in the case of which, in a first step, at least one frictionally locking unit 16 is preassembled, that is to say one structural unit is produced, by in each case at least the frictionally locking lever 17, the spring 21 and the fastening means 22, possibly also the guide element 23, being assembled to form one unit. In this way, a plurality of frictionally locking units 16 can also be preassembled. In a second step, the preassembled frictionally locking unit or units 16 is/are connected to the drive 1. It is particularly advantageous if, in the first step, furthermore, the carrier 14 or the abovementioned housing 14 is also combined together with the preassembled frictionally locking unit or units 16 to form one structural unit which is then connected to the drive 1 in the second step.

The connection of the fastening means 22 to the frictionally locking lever 17 takes place, in particular, by way of latching, the fastening means 22, in some embodiments, being pressed with its lower end into or through an opening 24 in the frictionally locking lever 17 and, as a result, being fixed on the frictionally locking lever 17 in a positively locking manner. Before the connection to the frictionally locking lever 17, the fastening means 22 can be connected to the guide element 23, it also being possible for the spring 21 to be arranged between the frictionally locking lever 17 and the fastening means 22 and/or guide element 23.

1. A frictionally locking arrangement for a drive of a closure element of a motor vehicle, which drive comprises an advancing gear mechanism with a mechanism component for producing drive movements, the frictionally locking arrangement having a carrier and at least one frictionally locking unit which is configured to transmit a frictional force and/or a frictional moment to the mechanism component,
wherein the at least one frictionally locking unit has a frictionally locking lever which is mounted with a first lever end pivotably on the carrier, which frictionally locking lever, on a first lever section which is spaced apart from the first lever end, has a force introduction device which is mounted on the carrier and is configured to introduce a force into the frictionally locking lever in a manner which is spaced apart from the first lever end, and which frictionally locking lever, on a second lever section which is arranged between the first lever end and the first lever section, has a first frictional element which is configured to transmit the frictional force or the frictional moment to the mechanism component.

2. The frictionally locking arrangement as claimed in claim 1, wherein the mechanism component is a drive spindle which rotates.

3. The frictionally locking arrangement as claimed in claim 1, wherein the frictionally locking lever, by way of its first lever end, and/or the force introduction device is mounted on the carrier, and wherein the force introduction device is supported on the carrier.

4. The frictionally locking arrangement as claimed in claim 1, wherein the force introduction device can be adjusted, in particular in such a way that an adjustment brings about a change in the position of the frictionally locking lever relative to the carrier and/or a change in the force, with which the frictionally locking lever is pressed away from the carrier.

5. The frictionally locking arrangement as claimed claim 1, wherein the force introduction device has a helical spring which loads the frictionally locking lever on the first lever section with a spring force and wherein the spring presses the frictionally locking lever away from the carrier.

6. The frictionally locking arrangement as claimed in claim 5, wherein the force introduction device has a fastening means for the spring, which fastening means is configured to fix the spring on the frictionally locking lever, the fastening means being supported on the carrier.

7. The frictionally locking arrangement as claimed in claim 6, wherein the fastening means is mounted in a sliding manner on the frictionally locking lever.

8. The frictionally locking arrangement as claimed in claim 6, wherein the force introduction device has a guide element for the fastening means, and wherein the fastening means has a first thread and the guide element has a corresponding second thread the fastening means and the guide element being in screwed engagement with one another.

9. The frictionally locking arrangement as claimed in claim 8, wherein the spring is fixed and prestressed between the guide element and the frictionally locking lever.

10. The frictionally locking arrangement as claimed in claim 8, wherein the fastening means and the guide element interact with one another in such a way that a rotation of the fastening means relative to the guide element brings about a change in the spacing between the guide element and the frictionally locking lever.

11. The frictionally locking arrangement as claimed in claim 8, wherein the guide element has an anti-rotation safeguard which interacts with the frictionally locking lever.

12. The frictionally locking arrangement as claimed in claim 6, wherein the fastening means has a shank, which is slotted along the length at least once and/or a head which has a receptacle for a tool.

13. The frictionally locking arrangement as claimed in claim 6, wherein the at least one frictionally locking unit, the spring and the fastening means, forms a preassembled unit, and wherein the guide element and/or the carrier are/is also part of the preassembled unit.

14. A drive for the motorized adjustment of a closure element of a motor vehicle, a frictionally locking arrangement as claimed in claim 1 being provided.

15. The drive as claimed in claim 14, wherein the drive has a drive motor and an advancing gear mechanism which is connected downstream of the drive motor, wherein the frictionally locking arrangement is connected between the drive motor and the advancing gear mechanism, and wherein the advancing gear mechanism is configured as a spindle/spindle nut mechanism with a spindle and a spindle nut which is assigned to the latter.

16. A closure element arrangement of a motor vehicle having a closure element which is coupled adjustably to the body of the motor vehicle, and having at least one drive for the motorized adjustment of the closure element as claimed in claim 14.

17. A method for producing a drive as claimed in claim 14, wherein, in a first step, at least one frictionally locking unit is preassembled, by at least the frictionally locking lever, the spring and the fastening means being assembled to form one unit, and, in a second step, the at least one preassembled frictionally locking unit is connected to the drive.

18. The method as claimed in claim 17, wherein, in the first step, furthermore, the guide element and/or the carrier are/is also preassembled together with at least the frictionally locking lever, the spring and the fastening means to form in each case one unit, and, in the second step, the respective preassembled unit is connected to the drive.

19. The method as claimed in claim 17, wherein, in the first step, the fastening means is connected to the frictionally locking lever by way of latching, wherein the fastening means is connected to the guide element before the connection to the frictionally locking lever, and wherein, before the connection of the fastening means to the frictionally locking lever, the spring is arranged between the frictionally locking lever and the fastening means and/or guide element.

20. The frictionally locking arrangement as claimed in claim 7, wherein the fastening means is secured on the frictionally locking lever counter to the direction of action of the spring force, and wherein the fastening means comes into contact with the frictionally locking lever on that side of the frictionally locking lever which faces away from the carrier.
